(19) United States
(12) Patent Application Publication
(10) Pub. No.: US 2010/0299054 A1
(43) Pub. Date: Nov. 25, 2010

(54) METHOD AND SYSTEM FOR MANAGING THE OPERATION OF A MOTOR VEHICLE AS A FUNCTION OF DRIVING CONDITIONS

(75) Inventors: Gonzalo Hennequet, Rueil Malmaison (FR); Pablo De Haro Sacristan, Paris (FR); Richard Balmy, Puteaux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/742,599

(22) PCT Filed: Nov. 5, 2008
(86) PCT No.: PCT/FR2008/051996

§ 371 Date: Jul. 16, 2010

(30) Foreign Application Priority Data
Nov. 12, 2007 (FR) 0758970

(51) Int. Cl. G06F 19/00

(52) U.S. Cl. 701/123

(57) ABSTRACT

A method of managing operation of a motor vehicle as a function of driving conditions of the vehicle during a journey towards a programmed destination includes: determining driving parameters relative to the journey to be taken; determining a position of the vehicle in the journey; and calculating a drive energy management law (EML) as a function of the position of the vehicle in the journey and of the driving parameters. The calculating the energy management law additionally dynamically calculates a vehicle propulsion mode from various propulsion modes available during the journey, the dynamic calculation including a calculation of a route along the journey as a function of the driving parameters.

The invention relates, generally, to the computation of an energy management law (EML) for motor vehicles.

The invention applies in particular to vehicles of hybrid type, that is to say to vehicles which comprise a power train comprising a traction internal combustion engine and an electric traction motor supplied by a supply battery on board the vehicle.

It also applies to electric vehicles with or without a range extender.

But it can also be applied to vehicles furnished with a single internal combustion power train.

As is known, one of the major concerns of motor vehicle constructors is to develop vehicles whose consumption and emissions are as low as possible, so as to meet the increasingly restrictive standards aimed at limiting pollutant emissions and consumption.

In this regard, the drivers of motor vehicles must increasingly submit to traffic flow constraints out of concern for respect for the environment.

Management of the motive energy within the vehicle is thus a crucial problem.

With the aim of reducing consumption and pollutant emissions as far as possible, motor vehicles are provided with a computer which formulates an energy management law able to manage the mode of operation of the vehicle, in particular by choosing the mode of traction, the distribution of power between the available sources, etc.

Certain advanced computers make it possible, in particular, to implement battery charging and discharging cycles so as, in particular, to select the mode of propulsion of the vehicle from among all the existing modes, namely those for which the motive energy is provided by an electric motor supplied by a traction battery, those for which the motive energy is provided by the electric motor and by the internal combustion engine and, if appropriate, those for which the motive energy is provided solely by the internal combustion engine, in proportions making it possible to limit consumption and emissions, while preserving an admissible minimum charge level for the battery.

In this regard it will be possible to refer to the document FR 2 845 643.

Certain computers formulate a motive energy management law by using data arising from a navigation system capable of determining the running parameters relating to a journey to be made, so as to manage the motive energy as a function of these parameters along the journey. This may involve, for example, choosing a mode of propulsion, for example electrical, hybrid or using a traction internal combustion engine only, so as to reduce consumption and pollutant emissions, as a function of the running parameters, such as the configuration of the road, the traffic, the imposed restrictions in terms of pollutant emissions, etc.

The document EP-A-1 256 476 proposes a system for computing an energy management law making it possible to achieve this objective.

Moreover, certain techniques make it possible to manage the motive energy of a vehicle either on the basis of driving characteristics specific to the driver, or on the basis of the characteristics of the trip. The documents US 2005 274553 and FR 2 811 268 describe such techniques.

In view of the foregoing, the aim of the invention is to allow improved management of the operation of a motor vehicle making it possible to take into account an increased number of parameters and, in particular, to adapt dynamically to modifications of these parameters.

The subject of the invention is therefore, according to a first aspect, a method for managing the operation of a motor vehicle as a function of the running conditions of the vehicle in the course of a journey to a programmed destination, comprising a step of determining running parameters relating to the journey to be made, a step of determining the position of the vehicle in the journey and a step of computing a motive energy management law as a function of the position of the vehicle in the journey and of the running parameters.

According to a general characteristic of this method, the step of computing the energy management law furthermore comprises a step of dynamic computation of a mode of propulsion of the vehicle from among various modes of propulsion available in the course of said journey, said dynamic computation comprising a computation of the route along said journey as a function of the running parameters.

According to another characteristic of this method, the step of determining the parameters relating to the running of the vehicle comprises the computation of at least one parameter chosen from among the traffic regulations for the trip, the state of the trip, and the pollutant emissions restrictions.

According to yet another characteristic, the method furthermore comprises a step of entering driving parameters relating to the mode of driving of the vehicle by the driver, the energy management law furthermore being computed on the basis of said driving parameters.

For example, the energy management law is furthermore computed as a function of the architecture of the vehicle.

It is furthermore possible to dynamically monitor the evolution of the running parameters along the trip.

It is possible, in this regard, to dynamically recompute a replacement route able to optimize the energy management law in the case of modification of the running parameters.

In one mode of implementation, in the course of the computation of the energy management law, the state of charge of a rechargeable electric traction supply source of the vehicle is managed.

It is furthermore possible to undertake cycles of recharging of the supply source as a function of the speed of the vehicle with respect to an authorized maximum speed.

It is further possible to manage the state of charge of the source as a function of a desired state of charge at the end of the trip.

The subject of the invention is also, according to a second aspect, a system for managing the operation of a motor vehicle as a function of running conditions of the vehicle in the course of a journey to a programmed destination, comprising a navigation system able to compute said journey and to determine running parameters relating to the journey to be made, and a computer comprising means for computing a motive energy management law as a function of the position of the vehicle in the journey and of the running parameters.

The computer furthermore comprises means of dynamic computation of a mode of propulsion of the vehicle from among various modes of propulsion available in the course of said journey, said navigation system furthermore being adapted for computing a replacement route as a function of the running parameters.

The management system furthermore comprises means for monitoring the evolution of the running parameters.

Other aims, characteristics and advantages of the invention will become apparent on reading the following description, given solely by way of nonlimiting example, and made with reference to the appended drawings in which:

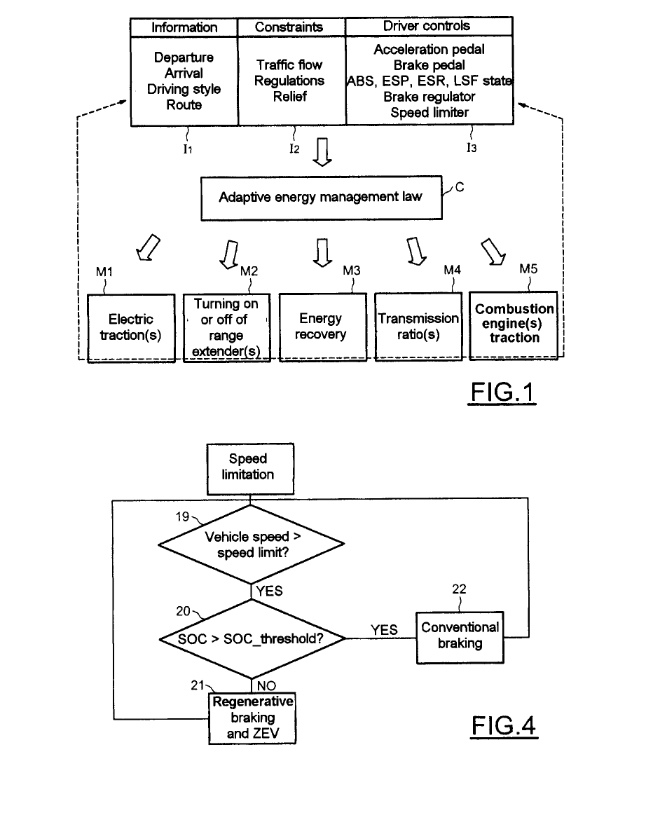

FIG. 1 is a schematic diagram illustrating the general architecture of a system for managing the operation of a motor vehicle in accordance with the invention;

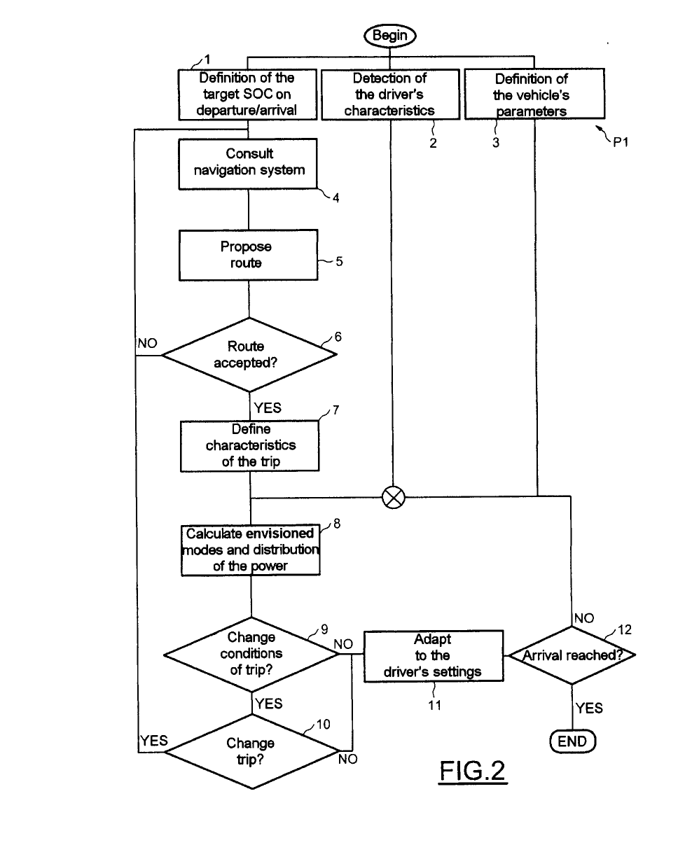

FIG. 2 is a flowchart illustrating the main phases of the management method according to the invention;

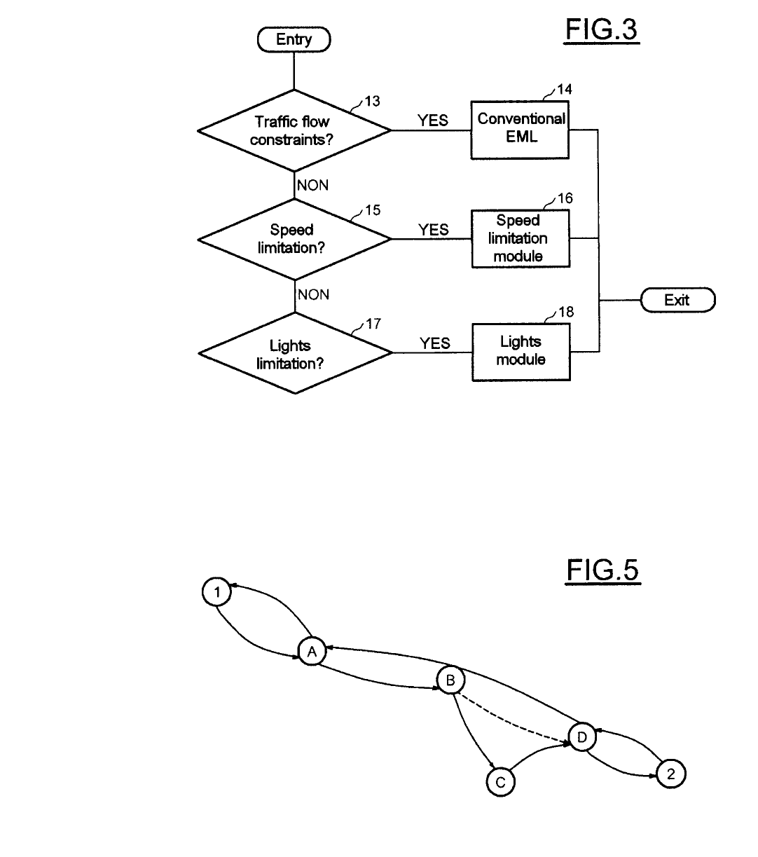

FIG. 3 is an exemplary formulation of an energy management law in accordance with the invention;

FIG. 4 is an exemplary implementation of a speed restriction procedure; and

FIG. 5 shows an exemplary recomputation of a route implemented by means of a management method in accordance with the invention.

The embodiment of the device and method of management which will now be described relates to the formulation of an adaptive energy management law (EML) for a hybrid vehicle. It thus relates to the formulation of an energy management law for a vehicle offering several operating modes, that is to say capable of operating either according to an electrical operating mode, or according to a mode according to which the motive energy is provided jointly by an electric motor and an engine, or indeed an operating mode according to which the motive energy is provided by an engine alone.

It will however be noted that the invention also applies, generally, to vehicles provided with a power train furnished solely with an engine and provided with an automatic transmission, furnished with a low-speed vehicle following mode or a speed regulating mode.

The management method is intended for the formulation of an energy management law (EML) making it possible to reduce fuel consumption and pollutant emissions by taking into account various running parameters relating to the driver, to the trip to be made, to the regulatory constraints and to the vehicle.

In particular, as regards the running parameters relating to the driver, the energy management law is formulated on the basis of parameters relating to the driving style desired by the driver, and of driving parameters formulated on the basis of the current state and of the forecast state of the controls on which the driver has the possibility of acting, such as the position of the accelerator pedal, of the brake pedal, of switches for controlling antilock braking systems (ABS), slip reduction systems (ESR), low-speed vehicle following (LSF), stability control (ESP), the position of the gear lever, the position of a system for choosing mode of propulsion, the state of the speed regulator, the state of the speed limiter, etc.

As regards the driving style desired by the driver, this running parameter can be formulated on the basis of a diagnostic of the mode of running of the vehicle, in the short and medium term, on the basis of the position and of the rate of depression of the accelerator pedal, of the brake pedal, of the position and of the rate of angular displacement of the steering wheel, etc. This parameter can also be entered directly by the driver by means of an appropriate man-machine interface.

The parameters relating to the journey to be made can, for example, be formulated by subdividing the journey into immediate and near fields, that is to say for example into fields extending in a span ranging for example from zero to a hundred meters, and ranging from 80 meters to a kilometer, respectively. Also undertaken, furthermore, is a definition of the journey, in terms of middle field, that is to say for a distance lying between 900 meters and 50% of the total distance of the trip and in terms of far fields, that is to say lying between 40% and the entire distance of the trip.

For each field, an analysis of the journey is undertaken so as to determine the presence of corners, the profile of the road, the possible presence of congestion or jams, the presence of zones in which the traffic flow is fluid, the presence of zones in which running constraints are applied to the driver, such as speed restrictions, traffic lights, signposts, or else the presence of works, or of zones for which pollutant emissions must be reduced or indeed totally avoided.

The state of various items of equipment of the vehicle such as the ABS, the ESP, the ESR, the LSF, the speed regulator, the speed limiter, etc. can be determined for a programmed journey.

Also undertaken is a computation of alternative routes, that the vehicle and its driver might need to follow if the running parameters need to change. The presence of corners, the profile of the road, the possible presence of jams, the presence of zones for which the traffic flow is fluid, the presence of traffic flow restrictions, etc. are also determined for each of the immediate, middle and far fields, as well as for each of the alternative routes.

The energy management law is furthermore formulated on the basis of additional running parameters, pertaining to the nature of the journey to be made, and relates for example to the presence of energy replenishment points, for example the presence of stations for recharging the electrical energy supply batteries, the presence of fueling points, etc.

It will be noted that, preferably, this information is provided by a navigation system of GPS type capable of utilizing information relating to the road network, that is to say relating to the configuration of the road, to the speed restrictions, to the specific regulations imposing restrictions of various kinds on the driver, in particular in terms of pollutant emissions and speed limit.

Thus, referring to FIG. 1, the energy management law is formulated by an embedded computer C on board the motor vehicle, on the basis of information I1, I2 and I3.

The information I1 is entered manually by the user. It relates in particular to the place of departure, to the place of arrival, to the driving style, or indeed to the route that the driver wishes to follow.

The information I2 relates to traffic flow constraints, for example in terms of speed, regulatory constraints (signaling, speed restriction, slowdowns, limitation of pollutant emissions, etc.), and to constraints pertaining to the configuration of the journey, for example in terms of relief. The information I3 relates to the driver's commands, applied for example to the accelerator pedal, to the brake pedal, and relates also to the state of the ABS, ESP, ESR, LSF systems, of the speed regulator and of the speed limiter. Said information is in particular intended for determining the driver's profile.

The computer C formulates the energy management law so as to implement various modes M1, M2, M3, M4 and M5 of operation of the vehicle, tending for example, and in a nonlimiting manner, to activate one or more electric traction systems (mode M1), to turn on or turn off range extension systems based for example on a fuel cell supplied with hydrogen to provide the electric vehicle with increased range (mode M2), to implement an energy recovery mode so as, for example, to recharge the traction battery (mode M3), to modify the transmission ratios (mode M4), or to implement a mode of traction by means of the engine (mode M5).

This EML law is updated dynamically as a function of the evolution of the various parameters entered manually or computed.

Referring now to FIG. 2, the formulation of the energy management law thus begins with a first phase P1 of entry in the course of which the driver manually enters the departure point and the arrival point of the journey to be made as well as, if appropriate, the quantity of residual charge of the traction battery that he wishes to preserve at the arrival point and the driving style (step 1). The acquisition of the driver's characteristics is also undertaken in the course of this first phase P1, for example, as indicated previously, on the basis of the previous trips or on the basis of the state or of the mode of actuation of the various controls actuatable by the driver (step 2). The acquisition of the parameters of the vehicle is moreover undertaken (step 3), by acquisition of the various components of the vehicle, its characteristics and its associations.

For example, in the course of this step 3, the computer C acquires information to ascertain whether the vehicle has an engine, an electric motor, batteries, a fuel cell, and acquires information relating to the transmission, to the reduction gear, to the fuel tank, to the power, to the capacity and to the torque of the drive means, and to the association, in series, in parallel, or mixed, of the various components of the vehicle.

During the following step 4, the computer C consults the vehicle's onboard navigation system. It thus acquires information relating to the trip envisioned so as to go from the departure point to the arrival point, to the position of the vehicle along the trip, to the traffic regulations along the trip, in terms of speed restriction, signaling, etc. to the state of the trip, for example pertaining to the presence of works, jams, or generally to the state of the traffic flow, to the restrictions of the pollutant emissions along the trip, so as to determine whether, for example, it is compulsory to run in electrical operating mode in town, or whether limitations of the pollutant emissions to a determined value are envisioned in certain zones of the journey.

During the following step 5, a route is proposed to the driver. If, during the following step 6, the driver accepts the proposed route, the computer undertakes a definition of the characteristics of the trip. In particular, in the course of this step, each stretch of the trip is associated with running parameters (step 7). These parameters are then combined with the parameters formulated previously during steps 2 and 3, pertaining to the characteristics of the driver and of the vehicle so as to formulate the actual energy management law (step 8).

In particular, the computer determines the operating mode of the vehicle, the state of each element of the vehicle, and the power distribution of each element of the vehicle at each instant of the trip, so as to minimize fuel consumption, while complying with the regulations for the trip, guaranteeing the proper operation of the vehicle and complying with the settings imposed by the driver.

It will be noted in this regard that the settings imposed by the driver can furthermore consist in providing for a minimum state of charge of the battery at the end of the trip, in avoiding certain zones of the journey or, conversely, in imposing certain zones, for example zones in which only running without any pollutant emission is permitted. It is also possible to provide for rechargings of the vehicle as well as the possible duration of this charging so as to optimize energy consumption, the cost of the energy possibly being variable as a function of the time of day.

Moreover, as seen, the computer and the associated navigation system monitor the evolution of the running parameters.

In particular, if, during the following step 9, a modification of the running conditions is detected, the computer can propose a change of route (step 10). If this change is accepted, the computer invokes the navigation system so as to recompute a replacement route. The procedure then returns to step 4 described previously.

In the converse case, that is to say if the driver does not wish to modify his trip, or if no modification of the running parameters is detected, during the following step 11, the system adapts to the driver's settings (step 11) and as long as the arrival has not been reached (step 12) it continues to compute the optimal modes of power distribution to carry out the trip.

Referring now to FIG. 3, in order to implement the procedure which has just been described, the computer comprises a certain number of computation blocks each ensuring the checking of a constraint and each intended to implement specific procedures making it possible to meet these constraints.

Thus, for example, in the exemplary embodiment illustrated, in which only three computation modules have been deployed, for the sake of simplicity, the computer monitors first of all, for example, the traffic flow constraints.

Thus, during a first step 13, the computer, on the basis of the previously defined inputs, detects whether traffic flow constraints such as signs, lights, etc. exist. If such is not the case, a conventional energy management law is implemented so as to optimize the vehicle's consumption (step 14).

If such is the case, successive steps of checking various constraints are undertaken.

For example, the following step 15 detects whether constraints related to speed restrictions exist. If such is the case, a speed restriction procedure is implemented (step 16).

If such is not the case (step 17), the computer detects whether constraints relating to traffic lights exist. If such is the case, a corresponding procedure 18 is implemented.

The monitoring is thus undertaken, in a successive manner, of all the previously defined constraints.

For example, referring to FIG. 4, as regards the speed restriction procedure, during a first step 19, a check is conducted to verify whether the speed of the vehicle is greater than an authorized speed limit.

If such is the case, during the following step 20, the state of charge SOC of the battery is compared with a threshold value SOC₋threshold. Thus, if the battery is not overly charged, the computer implements a phase of regenerative braking tending to recover energy so as to charge the electric traction battery (step 21). In the converse case, that is to say if the battery is overly charged, a conventional braking phase (step 22) is implemented.

Referring finally to FIG. 5, a first exemplary implementation of an energy management law will now be described.

This example is based on an assumption according to which a driver wishes to go from a point 1 to a point 2. After this information is entered, the navigation system analyzes the various possibilities for the trip and decides that the best option is to pass through the points A, B and D. However, it is considered that in the zone going from point 1 to point A, and from point D to point 2, pollutant emissions are prohibited.

In the course of the journey, the state of the lights, and generally, the signaling systems, as well as the state of the traffic, are taken into account both in the immediate field and in the near field. For example, if stopping of the vehicle is envisioned, for example at a light or at a halt sign, the computer stops the engine to envision a restart in electric traction mode. The EML is of course determined so as to allow a restart by means of the electric traction system alone.

Moreover, the computer computes the power distribution in the course of the journey so as reach the point D, to make it possible to carry out the trip from point D to point 2, but also to be able to set off again subsequently from the point 2 solely in electric traction mode, that is to say without any pollutant emissions.

For example, if the traffic flow conditions change in the course of time, for example while the driver is at point B, the computer proposes that the driver change route. If he accepts, he invokes the navigation system to get to point D by passing through point C. If the driver accepts this new route, the computer recomputes the power distribution so as to reach the point D with a sufficient level of battery charge.

As regards the return journey, to get to point 1, the navigation system determines the journey by passing through the points A-B-D and then 2. For example, the driver can be informed that at the point 1 a possibility exists of recharging the battery via the electrical network. The computer recomputes the power distribution for the whole of the envisioned cycle so as reach the destination point with a minimum state of battery charge and thus to use a maximum of electrical energy in the course of the journey.

According to another example, the vehicle travels along a journey with a variable slope, and the vehicle is furnished with a range enhancement system. In the example considered, the envisioned journey comprises a climb followed by a descent for which the speed is restricted to 70 km/h. Two kilometers after the end of the negative slope, a zone of 40 kilometers imposes an operating mode without pollutant emissions and the speed is restricted to 30 km/h. For example, the vehicle arrives at the start of the climb with a battery charge of below 50%.

The computer then computes the energy management law on the basis of the running parameters so as to reach the zone without pollutant emissions with a maximum charge in order to ensure running by electric traction for those 40 kilometers. Thus, the computer implements the range enhancement system in the course of the climb. In the descent, knowing that the speed is restricted to 70 km/h, a regenerative braking phase is implemented so as to recharge the battery, jointly with the range enhancement system.

According to a third example, in urban running, a vehicle receives, for example, an item of information at an instant T1 indicating that in 50 meters, regulations will require it to restrict its speed to 50 km/h. The computer then undertakes a regenerative braking phase so as to adapt its speed if the battery charge is below a threshold value of the order of 60%, for example. At a subsequent instant T2, the vehicle receives another item of information according to which in 150 meters, a light will turn red in five seconds and will then turn back to green in twenty-five seconds. The computer then adapts the speed of the vehicle, while still performing regenerative braking if the battery charge is below the threshold value, so as to reach the light as the latter turns green.

1-9. (canceled)

10. A method for managing operation of a motor vehicle as a function of running conditions of the vehicle in a course of a journey to a programmed destination, comprising:
determining running parameters relating to the journey to be made;
determining a position of the vehicle in the journey; and
computing a motive energy management law (EML) as a function of the position of the vehicle in the journey and of the running parameters,
wherein the computing the energy management law (EML) further comprises dynamic computation of a mode of propulsion of the vehicle from among various modes of propulsion available in the course of the journey, the dynamic computation comprising a computation of a route along the journey as a function of the running parameters, and
wherein the determining the running parameters relating to the running of the vehicle comprises computation of at least one parameter chosen from among traffic regulations for the journey, a state of the journey, pollutant emissions restrictions.

11. The method as claimed in claim 10, further comprising entering driving parameters relating to the mode of driving of the vehicle by a driver, the energy management law (EML) further being computed based on the driving parameters.

12. The method as claimed in claim 10, in which the energy management law (EML) is further computed as a function of an architecture of the vehicle.

13. The method as claimed in claim 10, in which evolution of the running parameters of the journey is dynamically monitored.

14. The method as claimed in claim 13, wherein in a case of modification of the running parameters, a replacement route able to optimize the energy management law (EML) is dynamically recomputed.

15. The method as claimed in claim 10, wherein in the course of the computation of the energy management law (EML), a state of charge of a rechargeable electric traction supply source of the vehicle is managed.

16. The method as claimed in claim 15, in which cycles of recharging of the supply source are undertaken as a function of a speed of the vehicle with respect to an authorized maximum speed.

17. The method as claimed in claim 15, in which the state of charge of the vehicle is managed as a function of a desired state of charge at an end of the journey.

18. A system for managing operation of a motor vehicle as a function of running conditions of the vehicle in a course of a journey to a programmed destination, comprising:
a navigation system configured to compute the journey and to determine running parameters relating to the journey to be made; and
a computer comprising means for computing a motive energy management law (EML) as a function of a position of the vehicle in the journey and of the running parameters,
wherein the computer further comprises means for dynamic computation of a mode of propulsion of the vehicle from among various modes of propulsion available in the course of the journey, and
further comprising means for monitoring evolution of the running parameters, the navigation system further configured to compute a replacement route as a function of the running parameters, and
wherein the navigation system comprises means for computing at least one parameter chosen from among traffic regulations for the journey, a state of the journey, pollutant emissions restrictions.
